(19) United States
(12) Patent Application Publication
(10) Pub. No.: US 2018/0373134 A1
(43) Pub. Date: Dec. 27, 2018

(54) PROJECTOR APPARATUS, PROJECTION METHOD, AND STORAGE MEDIUM STORING PROGRAM

(71) Applicant: CASIO COMPUTER CO., LTD, Tokyo (JP)

(72) Inventor: Toru Takahama, Hamura-shi (JP)

(21) Appl. No.: 15/995,326

(22) Filed: Jun. 1, 2018

(30) Foreign Application Priority Data
Jun. 21, 2017 (JP) 2017-121160

(51) Int. Cl. G03B 21/20; G02B 27/09; G02B 27/00; G03B 21/00; H04N 9/31

(52) U.S. Cl. CPC G03B 21/2033; G02B 27/0955; H04N 9/3147; G03B 21/008; G03B 21/2066; G02B 27/0025

(57) ABSTRACT

A projector apparatus includes a projection unit that projects an image and a processor configured to acquire photographic images obtained by photographing, from a plurality of angles, a projection image projected by the projection unit onto a projection target surface, acquire a plurality of items of correction information from the acquired photographic images, determine an observation angle of the projection image on the projection target surface, select correction information from the acquired plurality of items of correction information, based on the determined observation angle, and cause the projection image projected by the projection unit to be corrected based on the selected correction information.

### CROSS-REFERENCE TO RELATED APPLICATIONS

This application is based upon and claims the benefit of priority from Japanese Patent Application No. 2017-121160, filed Jun. 21, 2017, the entire contents of which are incorporated herein by reference.

### BACKGROUND OF THE INVENTION

### 1. Field of the Invention

The present invention relates to a projector apparatus, a projection method, and a storage medium storing a program, preferable for the case where an image is projected onto a target of projection other than a dedicated screen.

### 2. Description of the Related Art

Since accurate color reproduction is not achieved by a projector that projects a color image onto a colored projection surface such as a wall, a technique is proposed that performs projection after correcting for the blending amounts of the primary colors by a transformation matrix, using a spectral reflectivity of the projection surface or color information under the light source (e.g., Jpn. Pat. Appln. KOKAI Publication No. 2007-259472).

The technique disclosed in the above-described patent literature is proposed based on the assumption that the entire projection surface is flat and single-colored, and is not applicable to the case where an image is projected onto a target of projection that has a curved surface caused by irregularities, swelling, etc., and that is not single-colored, such as a patterned curtain.

In addition, when the surface of the target of projection is uneven, as described above, the projected image appears differently according to the relative positional relationship between the viewer who views the projected image and the surface of the projection target.

The present invention has been made in consideration of the above-described circumstances, and the object of the invention is to provide a projector apparatus, a projection method, and a storage medium storing a program, capable of projecting an easily viewable image by reducing the effect of the target of projection as much as possible.

### SUMMARY OF THE INVENTION

According to one aspect of the present invention, there is provided a projector apparatus, comprising: a projection unit that projects an image; and a processor, wherein the processor is configured to: acquire photographic images obtained by photographing, from a plurality of angles, a projection image projected by the projection unit onto a projection target surface; acquire a plurality of items of correction information from the acquired photographic images; determine an observation angle of the projection image on the projection target surface; select correction information on the projection target surface from the acquired plurality of items of correction information, based on the determined observation angle; and cause the projection image projected by the projection unit to be corrected based on the selected correction information on the projection target surface.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows a setting environment of a projection range according to an embodiment of the present invention;

FIG. 2 is a block diagram showing a functional configuration of electronic circuits of a projector according to the embodiment;

FIG. 3 is a flowchart showing processing of color distribution setting of a screen according to the embodiment; and

FIG. 4 is a flowchart showing processing of correction mode settings according to the embodiment.

### DETAILED DESCRIPTION OF THE INVENTION

Hereinafter, an embodiment of the present invention applied to a projector will be explained in detail with reference to the accompanying drawings.

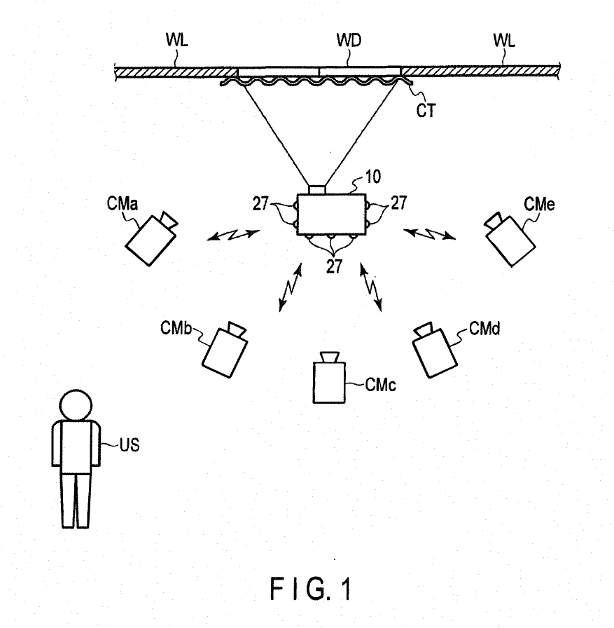

FIG. 1 illustrates setting of a projection environment that is performed at the start of placement of a projector 10, according to the present embodiment.

In the drawing, the projector 10 is placed to face a curtain CT with an uneven surface, provided instead of a screen.

It is desirable that the curtain CT is attached to a window WD in the wall surface WL, and has a pale color with a light-blocking effect.

Let us assume that the projector 10 includes, as human sensors, a plurality of infrared sensors 27 having a directivity of approximately 30° to 45°, for example, on each of three side surfaces of the main body housing other than the side surface on which a projection lens unit is provided, and that, when a user US is present in the periphery of the projector 10, the direction in which the user US is present can be detected by infrared rays emitted from the human body.

In a state in which the projector 10 is placed in the above manner and an all-white test image, for example, is projected onto the curtain CT by the projector 10, projection images are photographed from a plurality of angles around the projector 10, e.g., five directions as shown in the drawing, relative to the projection surface.

In this case, a parallel photographing operation may be performed by preparing a plurality of digital cameras, e.g., five digital cameras CMa to CMe as shown in the drawing, or a continuous photographing operation may be performed by moving the position of only one digital camera CMa.

Let us assume that, when a photographing operation is performed by the digital camera(s) CMa (to CMe), the projector 10 is allowed to detect the direction in which the user US who performs the photography is present, as described above, using an Ir light receiving unit, and to receive photographic image data obtained by the photography using, for example, a wireless LAN function.

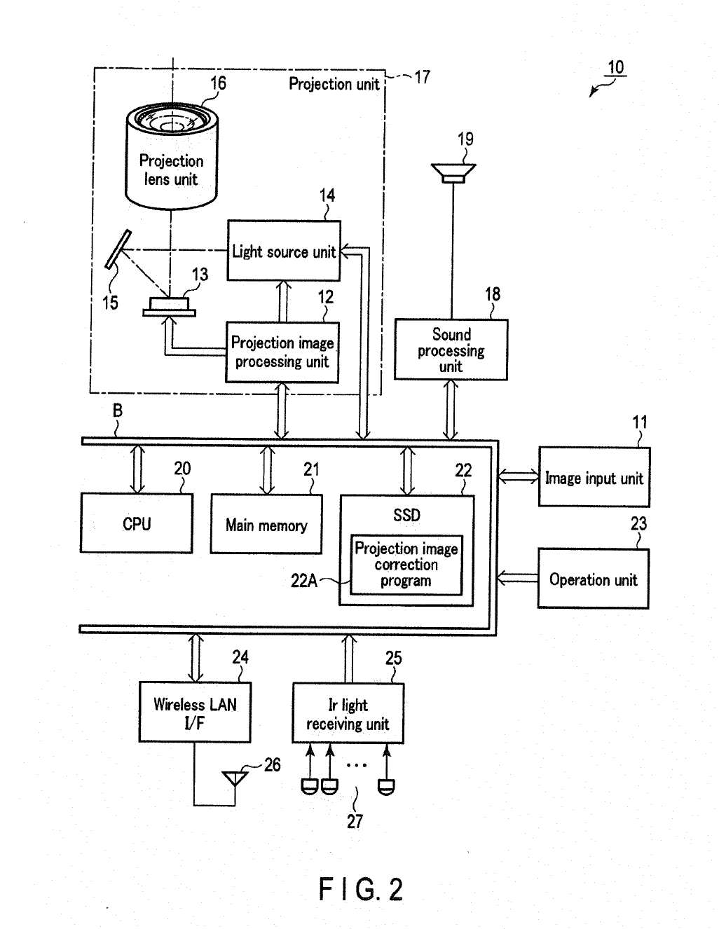

Next, the functional configuration of electronic circuits, in particular, of the projector 10 will be explained with reference to FIG. 2.

In the drawing, an image input unit 11 is configured by, for example, a pin-jack (RCA) type video input terminal, a D-sub15 type RGB input terminal, a High-Definition Multimedia Interface (HDMI) (registered trademark) terminal, a Universal Serial Bus (USB) terminal, etc.

An analogue or digital image signal in various standards that is input to the image input unit 11, or stored in a USB memory and selectively read therefrom, is sent to a projection image processing unit 12 via a bus B after being digitized in the image input unit 11 as needed.

In accordance with the sent image data, the projection image processing unit 12 drives a micromirror element 13, which is a display element, by time division driving at a frame rate corresponding to a predetermined format. For example, when the frame rate of the input image data is 60 frames per second, the micromirror element 13 is driven at a higher rate calculated by multiplying a division number of color components and the number of display gradation levels by 120 frames per second, which is double the frame rate of the input image data.

The micromirror element 13 quickly toggles on and off each of a plurality of microscopic mirrors arranged in an array of, for example, 1280×960 pixels to change the tilt angle for a display operation, thereby forming an optical image using the light reflected thereby.

On the other hand, light in primary colors (R, G, and B) is cyclically emitted from a light source unit 14 in a time-division manner.

The light source unit 14 has LEDs, which are semiconductor light-emitting elements, and repeatedly emits the R, G, and B primary color light in a time-division manner.

The LEDs of the light source unit 14 may include a laser diode (LD) or an organic EL element as an LED in a broad sense.

The primary color light from the light source unit 14 is completely reflected off a mirror 15, and is applied onto the micromirror element 13.

An optical image is formed by the reflection light at the micromirror element 13, and the formed optical image is projected to the outside via a projection lens unit 16 for display.

A projection unit 17 is configured by including the projection image processing unit 12, the micromirror element 13, the light source unit 14, the mirror 15, and the projection lens unit 16.

When a sound signal is included in an image signal input from the image input unit 11, the sound signal is separated from the image signal by the image input unit 11, and is sent to a sound processing unit 18 via the bus B.

The sound processing unit 18 includes a sound source circuit, such as a PCM sound source, converts a sound signal given at the time of the projection operation into an analogue form, and drives the speaker unit 19 to emit sound or generate a beep, for example, as needed.

All of the above-described operations of the circuits are controlled by the CPU (projection surface information selecting unit; projection control unit) 20.

The CPU 20 is connected to the main memory 21 and a solid-state drive (SSD) 22.

The main memory 21 is configured by, for example, an SRAM, and functions as a work memory of the CPU 20.

The SSD 22 is configured by an electrically-rewritable, non-volatile memory, such as a flash ROM, and stores various kinds of operation programs to be executed by the CPU 20, such as a projection image correction program 22A that will be described later, and various kinds of fixed data, such as On Screen Display (OSD) images to be superimposed on a base image.

The CPU 20 reads the operation programs, the fixed data, etc. stored in the SSD 22, and executes the programs after loading and storing them in the main memory 21, thereby integrally controlling the projector 10.

The CPU 20 executes various projection operations in response to an operation signal received from an operation unit 23 via the bus B.

The operation unit 23 includes a light receiving unit including a quantum-type (cooled-type) infrared sensor configured by, for example, a phototransistor that receives an infrared modulation signal from a key operation unit provided in the main body housing of the projector 10 or from a remote controller (which is not shown in the drawings) dedicated for the projector 10. The operation unit 23 accepts a key operation signal, and sends a signal corresponding to the accepted key operation signal to the CPU 20 via the bus B.

Furthermore, the CPU 20 is connected to a wireless LAN interface (I/F) (projection image acquiring unit) 24 and an Ir light receiving unit (angle determining unit) 25 via the bus B.

The wireless LAN interface 24 performs data transmission and reception to and from external devices including the digital cameras CMa to CMe, by wireless communication connection compliant with, for example, IEEE 802.11a/11b/11g/11n standards, via a wireless LAN antenna 26.

The Ir light receiving unit 25, which is a circuit provided inside the main body housing of the projector 10, accepts detection signals from a plurality of infrared sensors (angle determining units) 27 configured by thermal (non-cooled) elements such as pyroelectric elements, provided on the side surface of the main body housing of the projector 10, and determines a direction in which the user US is present from the detected signals.

In this case, by setting the detection angle ranges of adjacent infrared sensors 27 so as to overlap with each other, a dead angle can be eliminated at the time of detecting the position of the user US, and the angle of the direction in which the user US is present can be estimated more accurately based on the ratio between the levels of the detection signals from the adjacent infrared sensors 27.

Next, an operation example according to the above-described embodiment will be explained.

Herein, an explanation will be given about the operation at the time of initial setting before projection of a given image is started by the projector 10.

At the initial setting, the projector 10 is placed as shown in FIG. 1, and screen settings for acquiring a color distribution (color information) of the curtain CT that is to be the screen are performed in a state in which an all-white test image is projected onto the curtain CT.

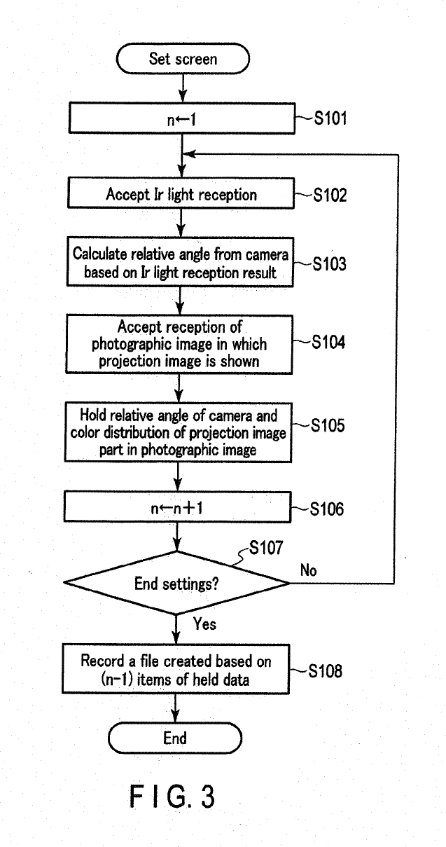

FIG. 3 is a flowchart illustrating the processing of the screen settings that constitute a part of the projection image correction program 22A stored in the SSD 22.

At the start of the processing, the CPU 20 sets the initial value “1” as a variable n for counting the number of times projection images are photographed (step S101).

The CPU 20 causes the Ir light receiving unit 25 to accept detection signals from the infrared sensors 27 (step S102).

Based on the detection signals accepted from the infrared sensors 27, the CPU 20 calculates a relative angle at which the user US holding the digital camera(s) CMa (to CMe) is present, relative to the housing of the projector 10 (step S103).

In this case, when the output level of one of the detection signals from the infrared sensors 27 is particularly high, the CPU 20 estimates that the user US is operating in an approximate center direction of the detection angle range of the corresponding infrared sensor 27.

When the output level of the detection signals of two adjacent infrared sensors 27 are higher than the others, the CPU 20 calculates an angle of the direction in which the user US is estimated to be present, in accordance with the ratio between the output levels of the detection signals of the two infrared sensors 27.

On the other hand, the CPU 20 receives and accepts, via the wireless LAN antenna 26 and the wireless LAN interface 24, a photographic image of the curtain CT sent from the digital camera(s) CMa (to CMe) in which the projection image is shown (step S104).

The CPU 20 extracts a projection image part of the photographic image accepted in step S104 as an image that represents a color distribution, associates the extracted image with the numerical value of the variable n and the information on the relative angle calculated in step S104, and then stores them in the SSD 22 (step S105).

As the image that represents the color distribution, an image showing a distribution of each of the primary color components R, G, and B with a 255-step gradation, for example, in a corresponding part of a photographic image obtained by photographing a projection image that is originally projected to be all-white is acquired and held.

Furthermore, the CPU 20 sets the numerical value of the variable n to be updated by +1, in preparation for the next holding of the image that represents a color distribution (step S106).

Based on whether or not a key operation has been made to end the series of settings by the operation unit 23, the CPU 20 determines whether or not the settings are to be ended (step S107).

When it is determined that a key operation to end the series of settings has not been made (No in step S107), the CPU 20 returns to the processing in step S102, and executes similar processing to acquire an image that represents a color distribution from another photography angle.

By thus repeating the processing from step S102 to step S107, a plurality of images that represent respective color distributions are acquired.

Subsequently, at the point in time when it is determined that the key operation has been made to end the series of settings in step S107 (Yes in step S107), the CPU 20 creates a file based on data including images that represent (n−1) color distributions held therein, and sets the file to be recorded in the SSD 22 (step S108). The processing in FIG. 3 is completed in the above manner.

In the above explanation, angle information about the direction in which the user US is estimated to be present and the information on the photographic image are associated and held each time. However, before a file is created and set to be recorded in step S108, a processing step may be adopted that estimates and assigns a positional relationship between a plurality of acquired photographic images based on the ratio in size between right and left sides, in particular, of projection image parts of the photographic images.

Next, an explanation will be given of the operation in the case where an image is projected while actually performing color correction necessary for the curtain CT after making settings on color distribution of the curtain CT that is to be the target of projection.

In the present embodiment, let us assume that, in response to a key operation by the operation unit 23, the projector 10 may optionally select one of three color distribution correction modes (referred to as “first correction mode” to “third correction mode” hereinafter and in the drawings) in accordance with the target of projection.

In the first correction mode, a position of one user US is detected, and a color distribution of an image to be projected is corrected in accordance with an angle of a direction in which the detected user US is estimated to be present.

In the second correction mode, a direction and a range in which correction is to be performed, as well as a correction coefficient, are obtained based on a result of detection of a direction and a range in which people are densely populated, and a color distribution of an image to be projected is corrected.

In the third correction mode, an average of the information on all the directions obtained by the screen setting processing in FIG. 3 is obtained, and a color distribution of an image to be projected is evenly corrected in all the directions in which the digital camera(s) CMa (to CMe) has performed photography.

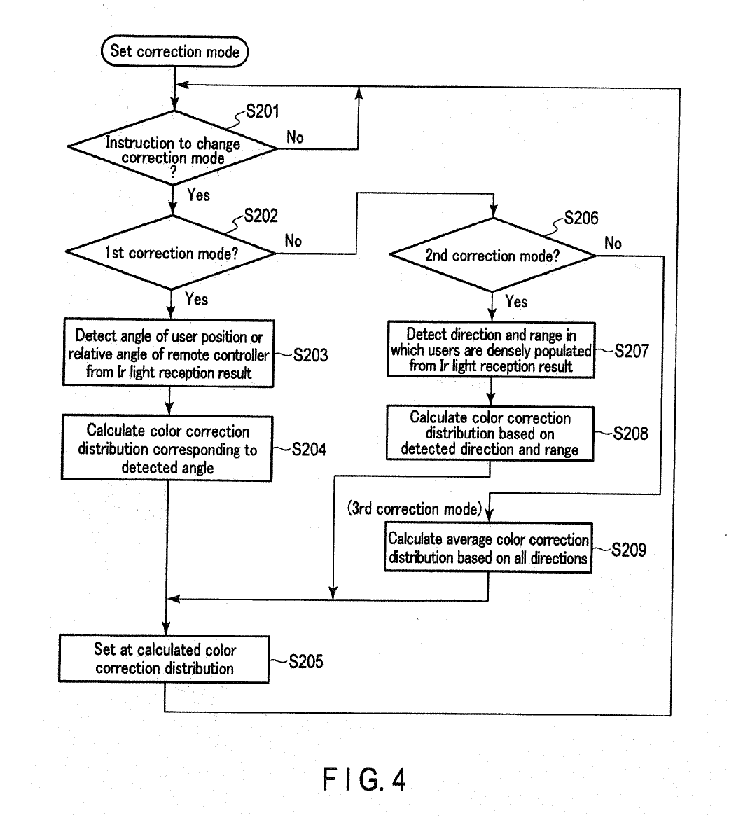

FIG. 4 is a flowchart illustrating the processing of the correction mode setting that constitutes a part of the projection image correction program 22A stored in the SSD 22.

At the start of the processing, the CPU 20 waits for input of a key operation signal that makes an instruction to change the correction mode from the operation unit 23 (step S201).

At the point in time when a key operation signal that makes an instruction to change the correction mode has been made (Yes in step S201), the CPU 20 determines whether or not the first correction mode has been designated from the key-operated content (step S202).

When it is determined that the first correction mode has been designated (Yes in step S202), the CPU 20 causes the Ir light receiving unit 25 to detect an angle of a position in which the user US is estimated to be present at this point in time, based on the content of the infrared sensor 27, such as a pyroelectric element, that outputs the highest level of detection signal, or detects a relative angle of the remote controller, based on the result of light reception at the light receiving unit including an infrared sensor such as a phototransistor that receives an infrared modulation signal from the remote controller (step S203).

If image data that represents a color distribution of an angle accurately corresponding to the detected angle is recorded in the SSD 22, the CPU 20 calculates image correction data to perform similar color correction for each distribution region, using the data (step S204).

If the image data that represents the color distribution of the angle accurately corresponding to the detected angle is not recorded in the SSD 22, the CPU 20 reads, from the SSD 22, image data that represents color distributions corresponding to the nearest two angles that interpose the detected angle, and performs interpolation processing in accordance with the angles, thereby obtaining image data that represents a pseudo-color distribution.

Using the obtained image data, image correction data to perform similar color correction for each distribution region is calculated.

Next, based on the calculated color correction data, the CPU 20 sets color correction of an image to be projected by the projection unit 17 (more precisely, color correction of an image displayed by driving of the micromirror element 13 by the projection image processing unit 12) to be executed for each distribution region in the subsequent projection operations (step S205), and returns to the processing in step S201, in preparation for the next instruction to change the correction mode.

When it is determined in step S202 that the key-operated content is not a designation of the first correction mode (No in step S202), the CPU 20 determines whether or not the key-operated content is the designation of the second correction mode (step S206).

When it is determined that the second correction mode is designated (Yes in step S206), the CPU 20 causes the Ir light receiving unit 25 to detect a direction and a range of the infrared sensor 27 that outputs a detection signal at a signal level higher than a preset threshold value at this point in time, thereby detecting an angle range of the direction in which people including the user US are estimated to be present (step S207).

The CPU 20 reads, from the SSD 22, data on a plurality of images that represent color distributions corresponding to the detected angle range, and performs computing processing to obtain an average thereof, thereby obtaining image data that represents a pseudo-color distribution in the angle range.

Using the obtained image data, image correction data to perform similar color correction for each distribution region is calculated (step S208).

The CPU 20 proceeds to step S205, at which, based on the calculated color correction data, color correction of an image to be projected by the projection unit 17 is set to be executed for each distribution region in the subsequent projection operations, and returns to the processing in step S201, in preparation for the next instruction to change the correction mode.

If it is determined in step S206 that the key-operated content is not the designation of the second correction mode either (No in step S206), the CPU 20 logically regards that the third correction mode has been designated. In this case, the CPU 20 collectively reads, from the SSD 22, data on a plurality of images that represent color distributions corresponding to all the angles recorded in the SSD 22, and performs computing processing to obtain an average thereof, thereby obtaining image data that represent pseudo-color distributions corresponding to all directions.

Using the obtained image data, image correction data to perform similar color correction for each distribution region is calculated (step S209).

The CPU 20 proceeds to step S205, at which, based on the calculated color correction data, color correction of an image to be projected by the projection unit 17 is set to be executed for each distribution region in the subsequent projection operations, and returns to the processing in step S201, in preparation for the next instruction to change the correction mode.

Thus, even when the curtain CT that is to be the target of projection used as a screen is not in a white, solid color, it is possible to provide an easily viewable image by reliably performing color correction of an image projected thereon, in accordance with the correction mode designated by the user US.

According to the above-described embodiment, a projector apparatus includes: a wireless LAN interface (I/F) (projection image acquiring unit) 24 and a wireless LAN antenna (projection image acquiring unit) 26 that acquires photographic images obtained by photographing, from a plurality of angles, a projection image projected by the projection unit 17 onto a projection target surface; a CPU (correction information acquiring unit) 20 that acquires a plurality of items of correction information from the photographic images acquired by the wireless LAN interface (I/F) (projection image acquiring unit) 24 and the wireless LAN antenna (projection image acquiring unit) 26; an infrared sensor (angle determining unit) 27 that determines an observation angle of the projection image on the projection target surface; a CPU (projection surface information selecting unit) 20 that acquires color information on the projection target surface from the plurality of items of correction information acquired by the CPU (correction information acquiring unit) 20 on the basis of the observation angle determined by the infrared sensor 27; and a CPU (projection control unit) 20 that subjects the image projected by the projection unit 17 to color correction on the basis of the color information on the projection target surface acquired by the CPU 20.

However, the correction information on the projection target surface acquired by the CPU (projection surface information selecting unit) 20 is not limited to color information.

For example, the CPU (projection surface information selecting unit) 20 may acquire shape information on the projection target surface.

According to the above-described embodiment, it is possible to project an easily viewable image by reducing the effect of the target of projection as much as possible.

In the above-described embodiment, by acquiring the angle of the direction in which the user US who performs an operation on the remote controller (which is not shown in the drawings) of the projector 10 or who performs photography using the digital camera(s) CMa (to CMe) is present, the angle can be easily identified in association with the input timing thereof, and the complicated operation on the side of the user US can be simplified, thus improving the usability in various operations.

Furthermore, in the above-described embodiment, a case has been explained where the angle of the direction in which people including the user US are present can be detected by providing a plurality of thermal (non-cooled) infrared sensors 27, such as pyroelectric elements, having a directivity on the side surfaces of the main body housing of the projector 10, for example, and configuring a human sensor unit with the Ir light receiving unit 25.

However, the present invention is not limited thereto. An angle of the direction in which people are present may be detected by, for example, providing an imaging unit relatively small in image size on each side surface of the housing of the projector 10, or providing an omnidirectional imaging unit at an upper part of the main body housing of the projector 10, and subjecting an image obtained by photography to image processing such as contour extraction and face recognition.

In this case, by acquiring information on the distance to each person in association with the autofocus function, and acquiring information on the projection distance based on the focus lens position in the projection lens unit 16, the projection position on the target of projection and the arrangement situation of the projector 10 and people who are present in the periphery of the projector 10 can be accurately observed, and an image to be projected can be color-corrected more accurately for better viewability without causing a sense of incongruity.

Moreover, instead of the infrared sensor 27, a Doppler sensor, for example, that detects the position of a moving object using reflection of electronic waves or ultrasonic waves may be used to detect the angle of the direction in which the user US, for example, is present.

Furthermore, in the second correction mode of the above-described embodiment, a case has been explained where average color correction processing is performed on the basis of the angle range in which the user US, for example, is present, on an image that can be viewed from the range.

By thus setting the angle as a range, a plurality of people in the range can share an easily viewable projection image.

Moreover, in the third correction mode of the above-described embodiment, a case has been explained where average color correction processing is performed on the basis of the entire range in which the image projected on the curtain CT is viewable.

By thus setting the entire range in which the image can be viewed, a plurality of people can share an easily viewable projection image even in the case where, for example, an image is projected as a background in an environment in which an unspecified number of people are present.

Thus, by allowing a color correction mode to be optionally selected in accordance with the projection environment, an easily viewable image that is optimum at that point in time can be projected in accordance with the usage environment of the projector 10.

The present invention is not limited to the above-described embodiments, and can be modified in various manners in practice when implementing the invention without departing from the gist of the invention.

Moreover, the embodiments may be suitably combined, and an effect obtained by the combination may be achieved. Furthermore, the above-described embodiments include various inventions, and a variety of inventions can be derived by suitably combining structural elements disclosed in connection with the embodiments.

For example, if the object of the invention is achieved and the advantages of the invention are attained even after some of the structural elements disclosed in connection with the embodiments are deleted, the structure made up of the resultant structural elements can be extracted as an invention.

What is claimed is:

1. A projector apparatus, comprising:
a projection unit that projects an image; and
a processor, wherein the processor is configured to:
acquire photographic images obtained by photographing, from a plurality of angles, a projection image projected by the projection unit onto a projection target surface;
acquire a plurality of items of correction information from the acquired photographic images;
determine an observation angle of the projection image on the projection target surface;
select correction information on the projection target surface from the acquired plurality of items of correction information, based on the determined observation angle; and
cause the projection image projected by the projection unit to be corrected based on the selected correction information on the projection target surface.

2. The projector apparatus according to claim 1, wherein the correction information includes color information or shape information.

3. The projector apparatus according to claim 1, wherein the processor is configured to:
acquire an angle at which a person is present, and
apply the acquired angle to the observation angle in the determination of the observation angle.

4. The projector apparatus according to claim 2, wherein the processor is configured to:
acquire an angle at which a person is present, and
apply the acquired angle to the observation angle in the determination of the observation angle.

5. The projector apparatus according to claim 1, wherein the processor is configured to:
determine the observation angle of the projection image on the projection target surface as a range in the determination of the observation angle, and
select correction information on the projection target surface from the acquired photographic images, based on the determined range of the observation angle in the selection of the correction information.

6. The projector apparatus according to claim 2, wherein the processor is configured to:
determine the observation angle of the projection image on the projection target surface as a range in the determination of the observation angle, and
select correction information on the projection target surface from the acquired photographic images, based on the determined range of the observation angle in the selection of the correction information.

7. The projector apparatus according to claim 3, wherein the processor is configured to:
determine the observation angle of the projection image on the projection target surface as a range in the determination of the observation angle, and
select correction information on the projection target surface from the acquired photographic images, based on the determined range of the observation angle in the selection of the correction information.

8. The projector apparatus according to claim 4, wherein the processor is configured to:
determine the observation angle of the projection image on the projection target surface as a range in the determination of the observation angle, and
select correction information on the projection target surface from the acquired photographic images, based on the determined range of the observation angle in the selection of the correction information.

9. The projector apparatus according to claim 1, wherein the processor is configured to:
determine an entire observation range in which the projection image on the projection target surface is viewable in the determination of the observation angle, and
select an average value of correction information on the projection target surface from the acquired photographic images based on the determined range of the observation angle in the selection of the correction information.

10. The projector apparatus according to claim 2, wherein the processor is configured to:
determine an entire observation range in which the projection image on the projection target surface is viewable in the determination of the observation angle, and
select an average value of correction information on the projection target surface from the acquired photographic images based on the determined range of the observation angle in the selection of the correction information.

11. The projector apparatus according to claim 3, wherein the processor is configured to:
determine an entire observation range in which the projection image on the projection target surface is viewable in the determination of the observation angle, and
select an average value of correction information on the projection target surface from the acquired photographic images based on the determined range of the observation angle in the selection of the correction information.

12. The projector apparatus according to claim 4, wherein the processor is configured to:
determine an entire observation range in which the projection image on the projection target surface is viewable in the determination of the observation angle, and
select an average value of correction information on the projection target surface from the acquired photographic images based on the determined range of the observation angle in the selection of the correction information.

13. A projection method applied to an apparatus including a projection unit that projects an image, the method comprising:
acquiring photographic images obtained by photographing, from a plurality of angles, a projection image projected by the projection unit onto a projection target surface;
acquiring a plurality of items of correction information from the acquired photographic images;
determining an observation angle of the projection image on the projection target surface;
selecting correction information on the projection target surface from the acquired plurality of items of correction information, based on the determined observation angle; and
causing the projection image projected by the projection unit to be corrected based on the selected correction information on the projection target surface.

14. A non-transitory computer-readable storage medium having a program stored thereon which controls a computer incorporated into an apparatus including a projection unit that projects an image, to perform functions comprising:
a projection image acquiring unit that acquires photographic images obtained by photographing, from a plurality of angles, a projection image projected by the projection unit onto a projection target surface;
a correction information acquiring unit that acquires a plurality of items of correction information from the photographic images acquired by the projection image acquiring unit;
an angle determining unit that determines an observation angle of the projection image on the projection target surface;
a projection surface information selecting unit that selects correction information on the projection target surface from the plurality of items of correction information acquired by the correction information acquiring unit, based on the observation angle determined by the angle determining unit; and
a projection control unit that causes the projection image projected by the projection unit to be corrected based on the correction information on the projection target surface selected by the projection surface information selecting unit.
